(19) United States
(12) Patent Application Publication
(10) Pub. No.: US 2026/0116657 A1
(43) Pub. Date: Apr. 30, 2026

(54) ROTARY LIFT SYSTEM FOR FRONT END LOADER

(71) Applicant: Oshkosh Corporation, Oshkosh, WI (US)

(72) Inventors: Ryan Ullius, Oshkosh, WI (US); Martin Schimke, Red Granite, WI (US); Caleb Binder, Oshkosh, WI (US); Eric Beidler, Oshkosh, WI (US); Jeremy Kiekhaefer, Oshkosh, WI (US); Vince Schad, Oshkosh, WI (US); Bennett Unfried, Oshkosh, WI (US); Andy Cornelius, Oshkosh, WI (US)

(21) Appl. No.: 19/003,568

(22) Filed: Dec. 27, 2024

Related U.S. Application Data
(60) Provisional application No. 63/615,737, filed on Dec. 28, 2023.

(51) Int. Cl. B65F 3/04; B65F 3/02

(52) U.S. Cl. CPC B65F 3/041; B65F 2003/0243; B65F 2003/0279

(57) ABSTRACT

A refuse vehicle includes a chassis, a body coupled to the chassis, the body assembly defining a refuse compartment, and a lift assembly pivotably coupled to the body assembly. The lift assembly includes a plurality of lift arms; a motor assembly coupled to the body; and a drive chain assembly coupled to the motor assembly. The motor assembly has a first end coupled to a first lift arm of the plurality of lift arms, and a second end coupled to the second lift arm of the plurality of lift arms. The drive chain assembly is driven by the motor assembly to rotate the lift arms about an axis defined by a joint to selectively engage the refuse compartment.

### CROSS-REFERENCE TO RELATED APPLICATIONS

This application claims the benefit of and priority to U.S. Provisional Application No. 63/615,737, filed Dec. 28, 2023, the entire contents of which are hereby incorporated by reference herein.

### BACKGROUND

The present disclosure relates generally to the field of refuse vehicles. Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment of the present disclosure relates to a refuse vehicle including a chassis, a body coupled to the chassis; the body assembly defining a refuse compartment; and a lift assembly pivotably coupled to the body assembly. The lift assembly includes a plurality of lift arms; a motor assembly coupled to the body; and a drive chain assembly coupled to the motor assembly. The motor assembly has a first end coupled to a first lift arm of the plurality of lift arms, and a second end coupled to the second lift arm of the plurality of lift arms. The drive chain assembly is driven by the motor assembly to rotate the lift arms about an axis defined by a joint to selectively engage the refuse compartment.

In some embodiments, the drive chain assembly of the refuse vehicle includes a sprocket, an idler, and a chain coupled to the motor assembly. The sprocket, idler, and chain can rotate the lift arms about the joint.

In some embodiments, the drive chain assembly of the refuse vehicle includes a first sprocket, idler, and chain coupled to the motor assembly. The first sprocket, idler and chain can rotate a first lift arm of the one or more lift arms about the joint. The drive assembly can include a second sprocket, idler, and chain coupled to the motor assembly. The second sprocket, idler, and chain can rotate a second lift arm of the one or more lift arms about a second joint.

In some embodiments, the refuse vehicle includes a drive shaft. The drive shaft extends between the first lift arm and the second lift arm. A first end of the drive shaft forms the joint and a second end of the drive shaft forms a second joint.

In some embodiments, at least a portion of the drive chain assembly of the refuse vehicle is enclosed within one of the first lift arm or the second lift arm.

In some embodiments, the one or more lift arms have a semi-circular shape.

In some embodiments, the motor assembly of the refuse vehicle includes an electric motor and a gearbox. The electric motor energizes the drive chain assembly. The gearbox controls rotary motion of the drive chain assembly.

In some embodiments, the lift assembly of the refuse vehicle is oriented such that the joint is oriented substantially behind a top portion of a hopper of the refuse compartment when the lift arms are lifting.

In some embodiments, the drive chain assembly of the refuse vehicle includes a first chain and a second chain. The lift assembly may include a first torque spring tensioner and a second torque spring tensioner. The first torque spring tensioner increases or decreases tension in the first chain. The second torque spring tensioner increases or decreases tension in the second chain.

In some embodiments, the drive chain assembly of the refuse vehicle includes one or more chains. The lift assembly may include a guide coupled to the first lift arm. The guide positions the chain such that the chain follows a motion path of the first lift arm, wherein the guide is at least one of a chain track coupled to the first lift arm or an interior cavity of the first lift arm.

In some embodiments, the lift assembly of the refuse vehicle includes a first fork coupled to the first lift arm and a second fork coupled to the second lift arm. The first fork selectively engages a first end of a refuse container. The second fork selectively engages a second end of the refuse container. The first fork and the second fork hold the refuse container while being lifted into the refuse compartment. At least one of the first fork or the second fork may include a second lift system.

Another embodiment of the present disclosure relates to a lift assembly for a refuse vehicle. The lift assembly includes a lift arm, a chain coupled to the lift arm, and a rotary lift system. The lift arm includes a first end coupled to an exterior of the refuse vehicle and a second end extending outward from the exterior of the refuse vehicle. The rotary lift system includes an electric motor to produce rotational motion. The rotary lift system includes a gearbox assembly coupled to the electric motor to regular the rotational motion. The rotary lift system includes a drive chain assembly, comprising a sprocket and an idler. The drive chain assembly can drive the chain and the lift arm about a joint to selectively raise the lift arm to engage a refuse compartment on the refuse vehicle.

In some embodiments, the rotary lift system of the lift assembly includes a drive shaft. The drive shaft is coupled to at least one of the electric motor or the gearbox assembly. The drive shaft is configured to receive regulated rotational motion from the gearbox assembly to transmit the regulated rotational motion to the chain drive assembly to drive the chain.

In some embodiments, the lift arm of the lift assembly is a first lift arm. The lift assembly may include a second lift arm. A first end of the second lift arm is coupled to an exterior of the refuse vehicle. A second end of the second lift arm extends outward from the refuse vehicle. The lift assembly may include a first fork and a second fork to receive a refuse container. The first fork is coupled to the second end of the first lift arm and the second fork is coupled to the second end of the second lift arm. The one or more lift arms lift such that the first fork and the second fork are lifted at least partially into or above the refuse compartment such that the contents of the refuse container are transferred into the refuse compartment.

In some embodiments, the lift arm of the lift assembly is a semi-circular lift arm. The semi-circular lift arm follows a curved trajectory as it is driven about the joint.

Another embodiment of the present disclosure relates to a rotary lift system to drive motion of a lift assembly. The rotary lift system includes a motor to produce rotational motion, a gearbox assembly coupled to the motor, and a drive chain assembly. The gearbox assembly can regulate the rotational motion. The drive chain assembly includes a chain coupled to at least a portion of the lift assembly such that motion of the chain causes motion of the lift assembly. The drive assembly includes a sprocket coupled with the chain to drive the motion of the chain. The drive chain assembly includes an idler coupled with the chain to guide the chain as it moves through the lift assembly.

In some embodiments, the rotary lift system includes a plurality of lift arms. The chain can be configured to move the lift arms to selectively engage a refuse compartment on a top portion of a refuse vehicle.

In some embodiments, the rotary lift system includes a tensioner coupled to at least a portion of the chain. The tensioner increases or decreases a tension of the chain as the chain moves through the lift assembly.

In some embodiments, the tensioner includes at least one of a leaf spring tensioner, a torque spring tensioner, a torque spring tensioner coupled to a turnbuckle, an adjustable arm roller tensioner, a floating tensioner, or a channel guided rolling tensioner.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment;

FIG. 2 is a perspective view of a front-loading refuse vehicle with a front-loading lift assembly, according to an exemplary embodiment;

FIG. 3 is a side view of a refuse vehicle shown with lift arms in a fully lifted position by a front-loading lift assembly, according to an exemplary embodiment;

FIG. 4 is a side view of a rotary lift system for a refuse vehicle including a tensioner, according to an exemplary embodiment;

FIG. 5 is a side view of lift arms of a refuse vehicle in a partially lifted position, according to an exemplary embodiment;

FIG. 6 is a side view of a torque tensioner for a rotary lift system, according to an exemplary embodiment;

FIG. 7 is a diagram of a portion of a rotary lift system inclusive of a chain, a drive sprocket, an idler, and a tensioner, according to an exemplary embodiment;

FIG. 8 is a diagram of a portion of a rotary lift system for a refuse vehicle inclusive of a chain, a chain guide, a drive sprocket, an idler, and a tensioner, according to an exemplary embodiment;

FIG. 9 is a perspective view of a rotary lift system for a refuse vehicle, according to an exemplary embodiment; and

FIG. 10 is a side view of a rotary lift system inclusive of a drive sprocket and idler with a chain engaged thereto, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a rotary lift system for a front lift assembly of a refuse vehicle is shown, according to at least one embodiment. The rotary lift system includes an electrically actuated geartrain that controls movement of the lift arms without the use of a linear actuator that would otherwise require transfer of rotary-to-linear motion. The rotary lift system includes an electric motor positioned on a top portion of a body of the refuse vehicle, in between a pair of lift arms of the refuse vehicle. In some embodiments, the electric motor and/or gearbox is disposed at a location that is forward of a drive shaft of the refuse vehicle, which can reduce the required length of the lift arm needed to engage the geartrain.

The rotary lift system actuates the lift arms by moving a chain that extends along the length of each one of the pair of lift arms. In some embodiments, a chain is disposed within each lift arm, along a curved section of the lift arms. Such an arrangement can reduce exposure of the chain and geartrain to contaminants and reduce the risk of damage during use.

In some embodiments, the rotary lift system includes a drive sprocket and idler that are removably coupled to a drive shaft controlled by a gearbox and motor. In this way, the motor drives the rotary motion of the drive sprocket and idler, while the gearbox controls the speed of the rotary motion and thus the speed at which chain moves.

### Overall Vehicle

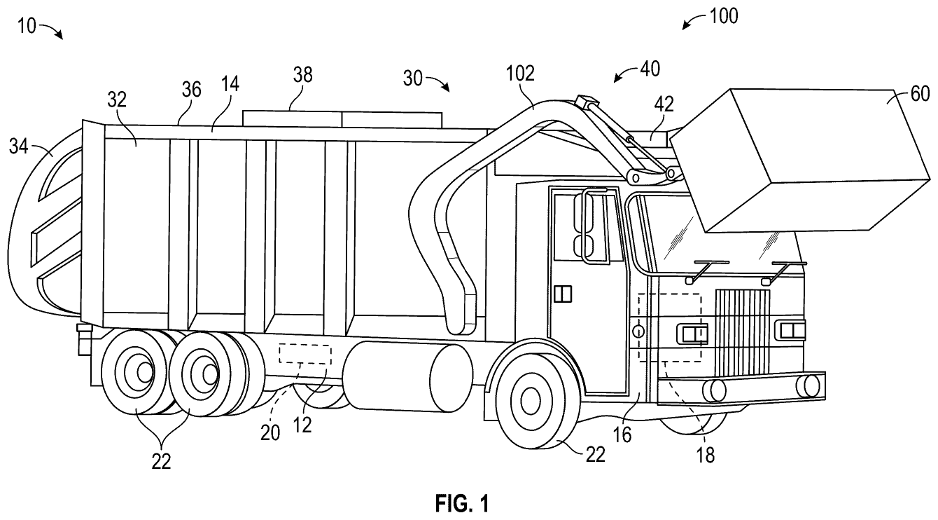

As shown in FIG. 1, a vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck. In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIG. 1, the refuse vehicle 10 includes a prime mover, shown as electric motor 18, and an energy system, shown as energy storage and/or generation system 20. In other embodiments, the prime mover is or includes an internal combustion engine. According to the exemplary embodiment shown in FIG. 1, the electric motor 18 is coupled to the frame 12 at a position beneath the cab 16. The electric motor 18 is configured to provide power to a plurality of tractive elements, shown as wheels 22 (e.g., via a drive shaft, axles, etc.). In other embodiments, the electric motor 18 is otherwise positioned and/or the refuse vehicle 10 includes a plurality of electric motors to facilitate independently driving one or more of the wheels 22. In still other embodiments, the electric motor 18 or a secondary electric motor is coupled to and configured to drive a hydraulic system that powers hydraulic actuators. According to the exemplary embodiment shown in FIG. 1, the energy storage and/or generation system 20 is coupled to the frame 12 beneath the body 14. In other embodiments, the energy storage and/or generation system 20 is otherwise positioned (e.g., within a tailgate of the refuse vehicle 10, beneath the cab 16, along the top of the body 14, within the body 14, etc.).

According to an exemplary embodiment, the energy storage and/or generation system 20 is configured to (a) receive, generate, and/or store power and (b) provide electric power to (i) the electric motor 18 to drive the wheels 22, (ii) electric actuators of the refuse vehicle 10 to facilitate operation thereof (e.g., lift actuators, tailgate actuators, packer actuators, grabber actuators, etc.), and/or (iii) other electrically operated accessories of the refuse vehicle 10 (e.g., displays, lights, etc.). The energy storage and/or generation system 20 may include one or more rechargeable batteries (e.g., lithium-ion batteries, nickel-metal hydride batteries, lithium-ion polymer batteries, lead-acid batteries, nickel-cadmium batteries, etc.), capacitors, solar cells, generators, power buses, etc. In one embodiment, the refuse vehicle 10 is a completely electric refuse vehicle. In other embodiments, the refuse vehicle 10 includes an internal combustion generator that utilizes one or more fuels (e.g., gasoline, diesel, propane, natural gas, hydrogen, etc.) to generate electricity to charge the energy storage and/or generation system 20, power the electric motor 18, power the electric actuators, and/or power the other electrically operated accessories (e.g., a hybrid refuse vehicle, etc.). For example, the refuse vehicle 10 may have an internal combustion engine augmented by the electric motor 18 to cooperatively provide power to the wheels 22. The energy storage and/or generation system 20 may thereby be charged via an on-board generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 10. In some embodiments, the energy storage and/or generation system 20 includes a heat management system (e.g., liquid cooling, heat exchanger, air cooling, etc.).

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment in. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30, a front-loading refuse vehicle, a side-loading refuse vehicle, etc.). In other embodiments, the storage volume is positioned between the hopper volume and the cab 16 (e.g., a rear-loading refuse vehicle, etc.).

As shown in FIG. 1, the refuse vehicle 10 includes a lift mechanism/system (e.g., a front-loading lift assembly, etc.), shown as lift assembly 100, coupled to the front end of the body 14. In other embodiments, the lift assembly 100 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 100 is configured to engage a container (e.g., a residential trash receptacle, a commercial trash receptacle, a container having a robotic grabber arm, etc.), shown as refuse container 60. The lift assembly 100 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 100 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

### Rotary Arm Lift Assembly

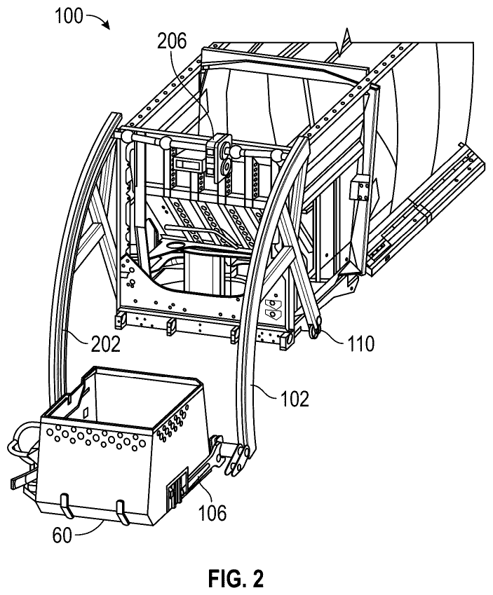

As shown in FIGS. 2-9, the lift assembly 40 is configured as a front-loading assembly, shown as front-loading lift assembly 100. According to an exemplary embodiment, the front loading lift assembly 100 is configured to facilitate lifting the refuse container 60 over the cab 16 to dump contents therein (e.g., trash, recyclables, etc.) into the refuse compartment 30 through an opening, shown as hopper opening 42, in the cover 36 of the body 14. As shown in FIGS. 2-5, the front-loading lift assembly 100 includes a pair of lift arms 102, each coupled to, and forming part of, the rotary lift system 200. The rotary lift system 200 includes a drive sprocket 210, idler 208, and chain 202 on each side of the rotary lift system 200 and coupled to each of the lift arms 102. Portions of the rotary lift system 200 on each side of the refuse vehicle (for each lift arm 102) are driven by a motor 204 and a gearbox 206. In this way, the lift arms 102 are raised using the motor 204.

Referring specifically to FIG. 2, a perspective view of the front-loading lift assembly 100 is shown, according to an exemplary embodiment. The front-loading lift assembly 100 includes the pair of the lift arms 102 coupled to a pair of the forks 106 at a first end and to the body 14 of the refuse vehicle 10 at a second end. The front-loading lift assembly 100 further includes a joint 110, about which the lift arms 102 rotate to move a container (e.g. container 60) over a front side of the cab 16 to dump the contents of the trash therein into the refuse compartment (e.g. refuse compartment 30 or a hopper opening 42). As shown in FIG. 2, the lift arms 102 are semi-circular in shape rather than linear. The semi-circular lift arms 102 may improve efficiency of the lifting motion. For example, the semi-circular lift arms 102 lift the refuse container 60 into the receptacle 30 to follow an arced motion path, which may reduce the strain on the lift arms 102 relative to the strain produced by a linear lift motion.

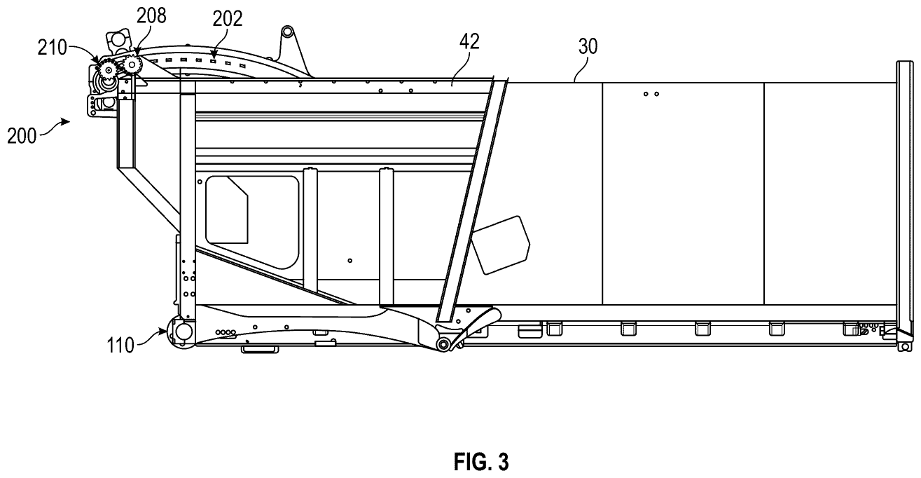

The lift assembly 100 is shown to include a rotary lift system 200. The rotary lift system is shown in greater detail in FIGS. 3-10. The rotary lift system 200 may be used to lift and rotate each of the lift arms 102 along a semi-circular path. Each lift arm 102 includes a sprocket, shown as drive sprocket 210, that is used in conjunction with a chain 202. The chain 202 extends along a length of each lift arm 102, according to some embodiments. In other embodiments, the chain 202 may extend along a portion of a lift arm 102.

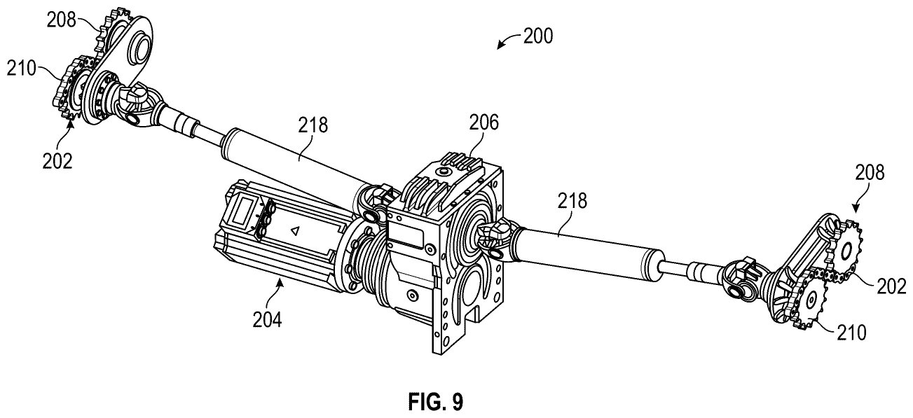

The drive sprocket 210 is driven to rotate by a motor, shown as the motor 204 in FIG. 9, and a gearbox 206. For example, the drive sprocket 210 receives a rotational force from the motor 204 or the gearbox 206. The drive sprocket 210 then supplies the rotational force to the chain 202 to drive motion in the chain 202. In this way, the rotary motion of the sprocket 210 produced by the motor 204 pulls the chain 202 to translate relative to the lift arm 102 the chain 202 is associated with. In some embodiments, an idler (e.g., idler 208) is included in each lift arm 102. The idler 208 is used in conjunction with the drive sprocket 210. For example, the idler 208 receives the moving chain 202 from the drive sprocket 210 to guide the motion of the chain 202. The motion of the chain 202 pulls the lift arms 102 and the forks 106 to pivot about a lateral axis defined by a joint 110, thereby raising and lowering the lift arms 102. The lift arms 102 the forks 106 continue to pivot around the joint 110 as the chain 202 is continuously pulled, thereby causing the container 60 to travel along the semicircular path from the ground to the hopper opening 42. When completely pivoted, the lift arms 102 and the forks 106 are in a position such that the container 60 is partially within the hopper opening 42 and can be emptied.

In exemplary embodiments, the chain 202 is located inside of the lift arms 102, such as within an interior cavity defined by the lift arms 102. The interior cavity including the chain 202 may be partially or completely enclosed within the lift arms 102. In this way, the chain 202 is protected from elements that may be exterior to the vehicle 10. For example, the chain 202 enclosed within the lift arms 102 is protected from weather (e.g., rain, snow, ice, extreme temperatures, humidity, UV exposure, wind, etc.), road conditions (e.g., dirt, debris, water, salt, etc.), impact (e.g., collisions with objects such as other vehicles or obstacles within the path of the lift), or any other exterior elements present outside of the vehicle 10. In other embodiments, the chain 202 may be located on the exterior of the lift arms 102. Additionally or alternatively, a track may be added to the lift arms 102 to support and guide the chain 202. In some embodiments, the interior cavity and/or track support the chain 202 along the curvature of the lift arms 102 so that the chain 202 moves in a curved trajectory along the length of the lift arms 102. As such, the chain 202 moves along approximately the same curvature as the lift arms 102 throughout the lifting process.

Referring now to FIG. 3, the front-loading lift assembly 100 is shown in a fully rotated position. In the fully rotated position, the container 60 is lifted into the hopper opening 42 and may be emptied into the refuse compartment 30. In this embodiment, the rotary lift system 200 is rotated such that it is positioned forward of the joint 110 when the lift arms 102 are fully pivoted. For example, the drive sprocket 210 and the idler 208 may be positioned at a distance extending outward from the front of the cab 16, while the joint 110 is maintained at a position at a shorter distance relative to the cab 16. In such a configuration, the rotary lift system 200 is positioned in a way that does not obstruct the motion path of the lift arms 102. In some embodiments, the drive sprocket 210 and the idler 208 maintain a fixed position throughout the lift. For example, the drive sprocket 210 and the idler 208 may be positioned at the same position forward of the joint 110 throughout the entire rotary motion path. In this embodiment, the drive sprocket 210 and the idler 208 may be fixed by a supporting member on the lift arms 102. The lift arms 102 and the chains 202 are then moved through the fixed sprocket 210 and idler 208. In some embodiments, the joint 110 may be or include a drive shaft 218, as shown in FIG. 9. The drive shaft 218 may have a first end coupled to an end of the first lift arm 102 and a second end coupled to an end of the second lift arm 102. The drive shaft 218 may be coupled to the ends of the lift arms 102 proximal to the cab 16. The ends of the drive shaft 218 may extend laterally between the lift arms 102. In that way, the drive shaft 218 pivotally couples the lift arms 102 to the frame 12. The drive system 218 may support the components within the lift assembly 100 and the rotary lift system 200. For example, the drive shaft 218 may be configured to support and fix the first ends of the lift arms 102 such that they do not get misaligned. In some embodiments, the drive shaft 218 may receive rotational motion from the rotary lift system 200. In this way, the drive shaft 218 delivers motion to the sprocket 210 and the idler 208 to drive the chain. FIG. 9, as described further herein, further describes how the drive shaft 218 is configured to transmit motion to lift the lift arms 102.

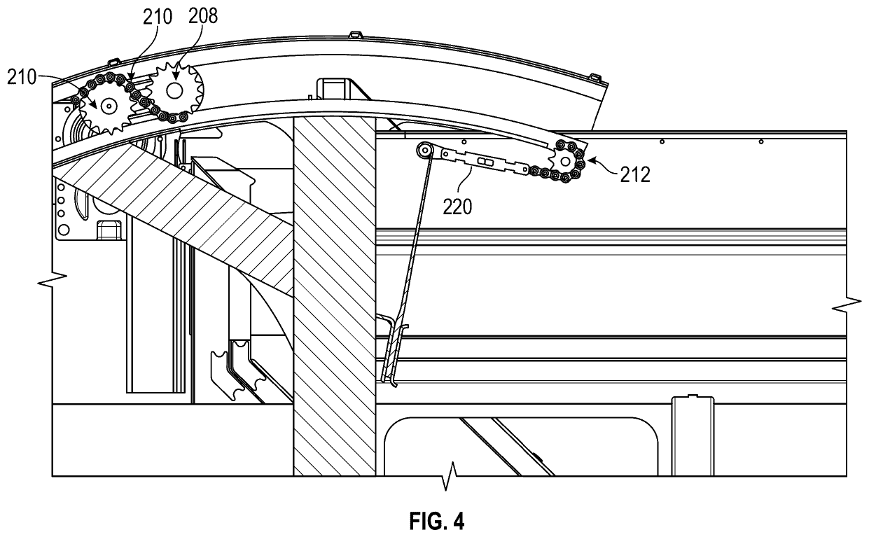

Referring now to FIG. 4, the front-loading lift assembly 100 is shown in a fully rotated position in which the container 60 may be emptied into the hopper opening 42 or another portion of the refuse compartment 30. In this embodiment, a tensioner, shown as a leaf spring tensioner 212, is coupled to the ends of the lift arms 102 that are coupled to the vehicle 10. In this exemplary embodiment, the drive sprocket 210 and the idler 208 are connected to the leaf spring tensioner 212 by the chain 202. The leaf spring tensioner 212 adjusts the tension in the chain 202 as it pulls the lift arms 102. Additionally or alternatively, the leaf spring tensioner 212 can dynamically adjust the tension in the chain 202 over time such that the rotary lift system 200 can properly operate without the need to replace the chain 202. In this figure, leaf spring tensioner 212 is a leaf spring tensioner to adjust tension in chain 202. The leaf spring tensioner 212 may flex to exert torque on the chain 202. The leaf spring tensioner 212 may include a turnbuckle 220 to further fine-tune the torque on the chain 202. The leaf spring tensioner 212 may be placed on the exterior of lift arms 102, or inside of the lift arms 102 to further protect the leaf spring tensioner 212 from the elements. In exemplary embodiments, the leaf spring tensioner 212 easily accessible, so that proper tension in the chain 202 may be maintained.

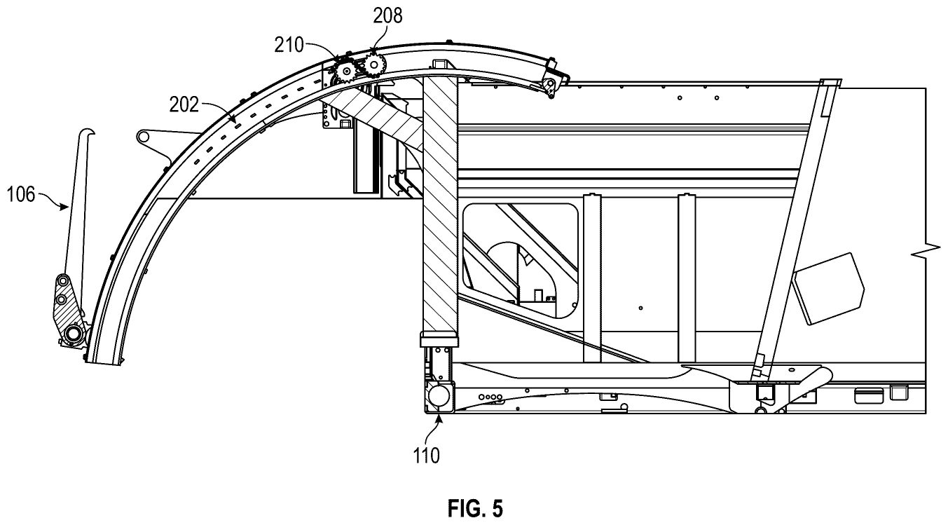

Referring to FIG. 5, the front-loading lift assembly 100 is shown in a partially rotated position, according to exemplary embodiments. The partially rotated position may refer to a position of the lift arms 102 while the lift assembly 100 is in the process of lifting. In this embodiment, the forks 106 are in an upright position. This may be accomplished by a traditional electronic linear actuator that is separate from the rotary lift system. In some embodiments, the forks 106 may each have a rotary lift assembly 200 to lift and lower the forks using a set of separate idlers 208, drive sprockets 210, and chains 202. In some embodiments, the forks 106 may be lifted and lowered by one or more electric motors coupled to the lift arms 102. In other embodiments, the same rotary lift system 200 of the lift assembly 100 can be configured to include additional components to drive the motion of the forks 106. The forks 106 may be lifted and lowered, or otherwise adjusted, to selectively engage the refuse container 60. For example, the forks 106 may be adjusted vertically to receive various heights of objects. For example, the forks 106 may be adjusted to an outward position to receive the refuse container 60 from the ground. In some embodiments, the forks 106 may be configured to extend and/or contract in the outward position. In this way, the forks 106 may receive the refuse container 60 when it is otherwise unable to be reached. For example, the forks 106 may extend to receive the refuse container 60 from a narrow space that the refuse vehicle 10 cannot otherwise move towards.

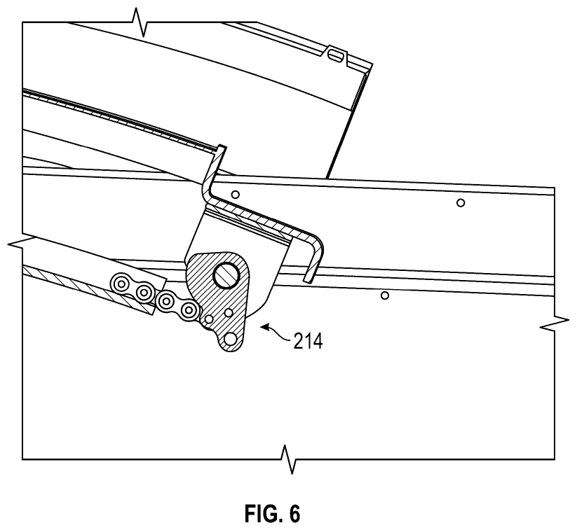

In the embodiment of FIG. 6, a tensioner, such as a torque spring tensioner 214, is coupled to the chain 202, to a proximal end of the chain 202. Similar to the leaf spring tensioner 212 in FIG. 4, the torque spring tensioner 214 may allow the rotary lift system 200 to operate over time without the need to replace the chain 202. Additionally, the torque spring tensioner 214 may be used to maintain proper tension in the chain 202 throughout the lift process (e.g., regardless of a position of the lift arms 102). The tension in the chain 202 may be adjusted, for example, by adjusting a bolt or twisting a torque spring on the torque spring tensioner 214. In some embodiments, the bolt or spring on the torque spring tensioner 214 is rotated in a first direction to increase the tension in the chain 202 and in a second direction to decrease tension in the chain 202. In the embodiment of FIG. 6, the torque spring tensioner 214 is coupled to the exterior of the refuse vehicle for ease of access.

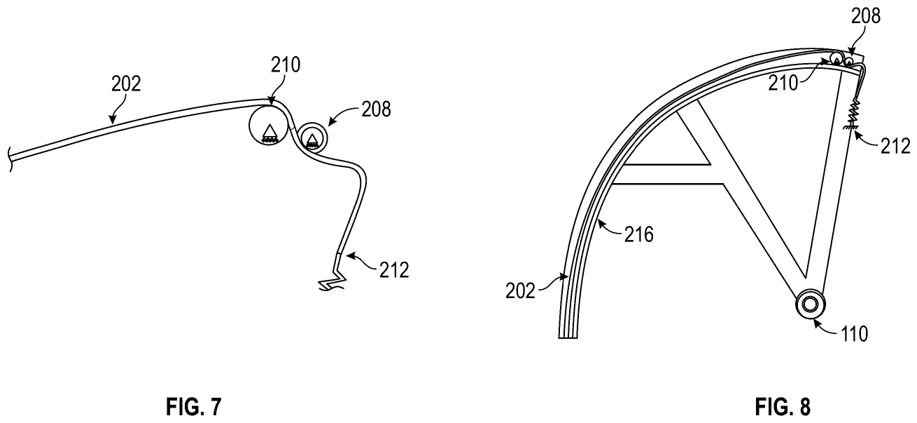

Referring to FIGS. 7 and 8, a drive chain assembly for a rotary lift assembly is shown, according to an embodiment. The drive chain assembly may include the idler 208, the drive sprocket 210, and the chain 202. The rotary lift assembly includes the drive chain assembly (e.g., the idler 208, the drive sprocket 210, the chain 202) and the leaf spring tensioner 212. Although shown as a leaf spring tensioner, the leaf spring tensioner 212 may be replaced with a spring-loaded adjustable arm tensioner, adjustable screw roller tensioner, adjustable arm roller tensioner, floating tensioner, channel guided roller tensioner, tensioning ring, torque spring tensioner, or some other type of tensioner.

Referring to FIG. 7, an isometric view of the rotary lift system 200 is shown, according to an exemplary embodiment. For example, the chain 108 is driven by the drive sprocket 210 and adjusted by the idler 208. Once the chain 202 passes through the idler 208, the leaf spring tensioner 212 receives a portion of the chain 202 to regulate the tension within the chain 202. In this embodiment, the chain 202 may be positioned loosely within the lift arms 102 (e.g., not on a track or otherwise guided). In this way, the motion control by the drive sprocket 210 and idler 208 pair and the tension control by the leaf spring tensioner 212 stabilizes and supports the chain 202 in the correct position.

Referring to FIG. 8, a chain guide 216 of a rotary lift system is shown, according to an exemplary embodiment. The chain guide 216 in this embodiment is disposed within the lift arm 102. The chain guide 216 may be located inside of the lift arm 102 along with the chain 202, or on the exterior of the lift arm 102. The chain guide 216 moves the chain 202 along the lift arm 102 and distributes loading to both sides of the chain 202. The chain guide 216 properly aligns the chain 202 and prevents the chain 202 from slacking or otherwise inefficiently operating. A support arm is coupled to the joint 110 and extends radially between the joint 110 and the lift arms 102, such that it divides the semi-circular structure near the center to provide support to the lift arms 102 when they rotate about the joint 110, according to exemplary embodiments. In some embodiments, an additional support beam may be added perpendicularly to the support arm.

Referring now to FIG. 9, a perspective view of the rotary lift system 200, according to an exemplary embodiment. In this embodiment, a gearbox 206 is coupled to a motor 204. The motor 204 may be an electric motor configured to energize the rotary lift system 200. The motor 204 may generate rotational energy when it receives power. An input shaft of the gearbox 206 may receive the rotational motion from the motor 204 to adjust the rotational motion. For example, one or more gears within the gearbox 206 may reduce the rotational motion. The gearbox 206 may also be configured to adjust the torque. The gearbox 206 and the motor 204 may be coupled to arms extending towards each of the lift arms 102 and their corresponding drive sprocket 210 and idler 208. In some embodiments, the rotary lift system 200 includes the drive shaft 218. The arms of the gearbox 206 and the motor 204 may be or include the drive shaft 218. In addition to fixing an end of the lift arms 102 to the vehicle 10, as described in FIG. 3, the drive shaft 218 may transmit motion to the lift arms 102. For example, the drive shaft 218 may be configured to receive the rotary motion from the gearbox 206 and transmit the rotary motion to the sprocket 210 and the idler 208 to drive the chain 202 to move the lift arms 102. The drive sprocket 210 and the idler 208 may be removably coupled to the drive shaft 218. In this way, the motor 204 provides the rotary motion needed to drive the sprocket 210 and the idler 208, while the gearbox 206 controls the speed of the rotary motion and thus the speed at which the chain 202 is moved, and the drive shaft 218 transmits the motion to lift the lift assembly 100. In some embodiments, the drive shaft 218 may be housed at least partially within a torque tube to help stabilize the motion transmitted by the drive shaft 218.

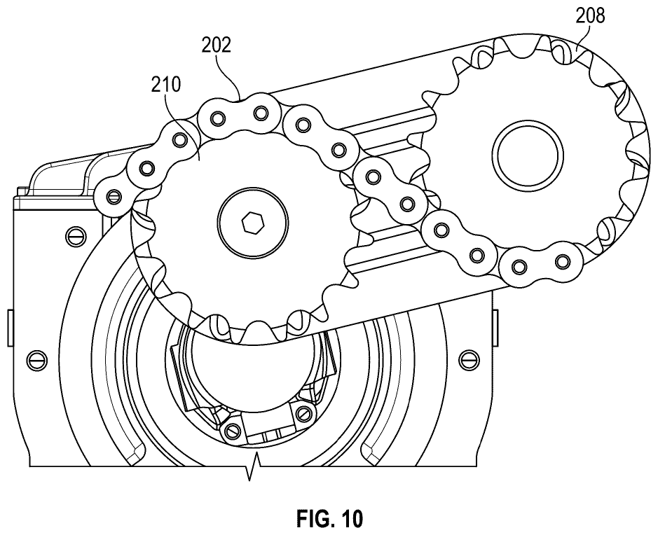

Referring to FIG. 10, a side view of a drive chain assembly. The drive chain assembly includes the drive sprocket 210 and the idler 208 with the chain 202 translationally coupled thereto is shown, according to an embodiment. In some embodiments, the chain guide 216 partially encloses the drive sprocket 210 and the idler 208 such that they are protected from environmental factors. In the embodiment of FIG. 10, the drive sprocket 210 and the idler 208 are removably coupled to the drive shaft 218 powered by the motor 204 and the gearbox 206. In this way, the drive sprocket 210 is rotated clockwise to move the chain translationally, while the idler 208 is rotated counterclockwise to further facilitate the translational motion of the chain. The chain 202 may be further fed into a tensioner (such as a leaf spring tensioner 212).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. For example, the spring assembly of the exemplary embodiment shown in at least FIG. 7 may be incorporated in the spring assembly of the exemplary embodiment shown in at least FIG. 4. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle comprising:
a chassis;
a body coupled to the chassis, the body defining a refuse compartment; and
a lift assembly pivotably coupled to the body, the lift assembly comprising:
a plurality of lift arms;
a motor assembly coupled to the body, the motor assembly having a first end coupled to a first lift arm of the plurality of lift arms and a second end coupled to a second lift arm of the plurality of lift arms; and
a drive chain assembly coupled to the motor assembly, wherein the drive chain assembly is driven by the motor assembly to rotate the first lift arm and the second lift arm about an axis defined by a joint to selectively engage the refuse compartment.

2. The refuse vehicle of claim 1, wherein the drive chain assembly comprises a sprocket, an idler, and a chain coupled to the motor assembly, and wherein the sprocket, the idler, and the chain are configured to rotate the first lift arm and the second lift arm about the joint.

3. The refuse vehicle of claim 1, wherein the drive chain assembly comprises:
a first sprocket, a first idler, and a first chain coupled to the motor assembly, wherein the first sprocket, the first idler, and the first chain are configured to rotate the first lift arm about the joint; and
a second sprocket, a second idler, and a second chain coupled to the motor assembly, wherein the second sprocket, the second idler, and the second chain are configured to rotate the second lift arm about a second joint.

4. The refuse vehicle of claim 3, wherein the motor assembly comprises a drive shaft extending between the first lift arm and the second lift arm, wherein a first end of the drive shaft forms the joint and the second end of the drive shaft forms the second joint, wherein the drive shaft is configured to transmit motion to the drive chain assembly.

5. The refuse vehicle of claim 3, wherein at least a portion of the drive chain assembly is enclosed within at least one of the first lift arm or the second lift arm.

6. The refuse vehicle of claim 1, wherein at least one of the first lift arm or the second lift arm have a semi-circular shape.

7. The refuse vehicle of claim 1, wherein the motor assembly comprises:
an electric motor configured to energize the drive chain assembly; and
a gearbox configured to control rotary motion of the drive chain assembly.

8. The refuse vehicle of claim 1, wherein the lift assembly is oriented such that the joint is oriented substantially behind a top portion of a hopper of the refuse compartment when the plurality of lift arms are lifting.

9. The refuse vehicle of claim 1, wherein the drive chain assembly comprises a first chain and a second chain, wherein the lift assembly further comprises:
a first torque spring tensioner, the first torque spring tensioner configured to increase or decrease tension in the first chain; and
a second torque spring tensioner, the second torque spring tensioner configured to increase or decrease tension of the second chain.

10. The refuse vehicle of claim 1, wherein the drive chain assembly comprises a chain, and the lift assembly comprises a guide coupled to the first lift arm, the guide configured to position the chain such that the chain follows a motion path of the first lift arm, wherein the guide is at least one of a chain track coupled to the first lift arm or an interior cavity of the first lift arm.

11. The refuse vehicle of claim 1, wherein the lift assembly further comprises:
a first fork coupled to the first lift arm, the first fork to selectively engage a first end of a refuse container; and
a second fork coupled to the second lift arm, the first fork to selectively engage a second end of the refuse container, wherein the first fork and the second fork hold the refuse container while the refuse container is lifted into the refuse compartment by the plurality of lift arms.

12. The refuse vehicle of claim 11, wherein at least one of the first fork or the second fork comprise a second lift system.

13. A lift assembly for a refuse vehicle, comprising:
a lift arm having a first end of the lift arm coupled to an exterior of the refuse vehicle and a second end of the lift arm extending outward from the exterior of the refuse vehicle;
a chain coupled to the lift arm; and
a rotary lift system, comprising:
an electric motor configured to produce rotational motion; and
a gearbox assembly coupled to the electric motor configured to regulate the rotational motion; and
a drive chain assembly, comprising a sprocket and an idler, the drive chain assembly configured to drive the chain and the lift arm about a joint to selectively raise the lift arm to engage a refuse compartment on the refuse vehicle.

14. The lift assembly of claim 13, wherein the rotary lift system comprises a drive shaft coupled to at least one of the electric motor or the gearbox assembly and the sprocket, wherein the drive shaft is configured to receive regulated rotational motion from the gearbox assembly and transmit the rotational motion to the sprocket to drive the chain.

15. The lift assembly of claim 13, wherein the lift arm is a first lift arm of a plurality of lift arms, the lift assembly further comprising:
a second lift arm having a first end coupled to an exterior of the refuse vehicle and a second end extending outward from the refuse vehicle; and
a first fork and a second fork configured to receive a refuse container, the first fork coupled to the second end of the first lift arm and the second fork coupled to the second end of the second lift arm.

16. The lift assembly of claim 13, wherein the lift arm is a semi-circular lift arm, the semi-circular lift arm configured to follow a curved trajectory as it is driven about the joint.

17. A rotary lift system to drive motion of a lift assembly, comprising:
a motor configured to produce rotational motion;
a gearbox assembly coupled to the motor, the gearbox assembly configured to regulate the rotational motion;
a drive shaft configured to rotate and coupled to the motor;
a drive chain assembly, comprising:
a chain coupled to at least a portion of the lift assembly such that motion of the chain causes motion of the lift assembly;
a sprocket coupled with the chain and the drive shaft, the sprocket configured to drive the motion of the chain upon rotation of the drive shaft; and
an idler coupled with the chain, the idler to guide the chain as the chain moves through the lift assembly.

18. The rotary lift system of claim 17, wherein the lift assembly comprises a plurality of lift arms, wherein the chain is configured to move the plurality of lift arms to selectively engage a refuse compartment on a top portion of a refuse vehicle.

19. The rotary lift system of claim 17, further comprising a tensioner coupled to at least a portion of the chain, the tensioner configured to increase or decrease a tension of the chain as the chain moves through the lift assembly.

20. The rotary lift system of claim 19, wherein the tensioner comprises at least one of a leaf spring tensioner, a torque spring tensioner, a torque spring tensioner coupled to a turnbuckle, an adjustable arm roller tensioner, a floating tensioner, or a channel guided roller tensioner.
